(19) United States
(12) Patent Application Publication
(10) Pub. No.: US 2022/0065562 A1
(43) Pub. Date: Mar. 3, 2022

(54) METHODS OF FORMING PROTECTIVE SURFACE TREATMENTS ON HEAT EXCHAGNERS IN-SITU

(71) Applicant: Carrier Corporation, Palm Beach Gardens, FL (US)

(72) Inventors: Matthew Patterson, East Syracuse, NY (US); Kerry Allahar, Syracuse, NY (US); Jefferi J. Covington, Baldwinsville, NY (US); Valerie Lisi, Cicero, NY (US)

(21) Appl. No.: 17/445,874

(22) Filed: Aug. 25, 2021

Related U.S. Application Data
(60) Provisional application No. 62/706,595, filed on Aug. 27, 2020.

(51) Int. Cl. F28F 13/18; F28F 19/02; C25D 11/04

(52) U.S. Cl. CPC F28F 13/18; F28F 21/084; C25D 11/04; F28F 19/02

(57) ABSTRACT

Disclosed is a method of in-situ application of a conformal surface treatment to an internal surface of a heat exchanger of a chiller comprising providing a surface treatment solution to an inlet of the heat exchanger of the chiller, urging a flow of the surface treatment solution along a flowpath from the inlet past a plurality of heat transfer tubes to an outlet of the heat exchanger of the chiller, collecting the surface treatment solution, forming the conformal surface treatment along an internal surface of the first manifold, the plurality of heat transfer tubes, the second manifold, and a plurality of interconnections therebetween, stopping the flow of the surface treatment solution, and removing the surface treatment solution from the chiller.

### CROSS REFERENCE TO A RELATED APPLICATION

The application claims the benefit of U.S. Provisional Application No. 62/706,595 filed Aug. 27, 2020, the contents of which are hereby incorporated in their entirety.

### BACKGROUND

Exemplary embodiments pertain to the art of coating aluminum parts. More particularly, the present disclosure relates to coated aluminum heat exchanger part and methods for manufacturing the same.

Aluminum offers a lighter, less expensive alternative to copper for the manufacture of heat exchangers. However, aluminum can be more susceptible to corrosion and fouling. For example, water cooled chillers can be exposed to a wide variety of water qualities that can cause corrosion and fouling of the water-bearing heat transfer tubes. Given the unique geometry, size, and weight of these tubes, it can be very difficult to efficiently and effectively coat them. As manufacturers seek to utilize aluminum or other non-traditional metals (e.g. other than copper) for the manufacture of heat exchanger tubes, there remains a need in the art for new coatings and cost-effective methods of their application.

### BRIEF DESCRIPTION

Disclosed is a method of in-situ application of a conformal surface treatment to an internal surface of a heat exchanger of a chiller comprising providing a surface treatment solution to an inlet of the heat exchanger of the chiller, urging a flow of the surface treatment solution along a flowpath from the inlet past a plurality of heat transfer tubes to an outlet of the heat exchanger of the chiller, collecting the surface treatment solution, forming the conformal surface treatment along an internal surface of the first manifold, the plurality of heat transfer tubes, the second manifold, and a plurality of interconnections therebetween, stopping the flow of the surface treatment solution, and removing the surface treatment solution from the chiller.

In addition to one or more of the above disclosed aspects or as an alternate wherein forming the conformal surface treatment further comprises forming the conformal surface treatment having a varying thickness along the flowpath and wherein the thickness is greatest at the inlet.

In addition to one or more of the above disclosed aspects or as an alternate wherein the forming further comprises heating the plurality of heat transfer tubes to a surface treatment temperature for a heating time duration

In addition to one or more of the above disclosed aspects or as an alternate wherein the surface treatment temperature is greater than or equal to 140° F. and the heating time duration is less than or equal to 30 minutes.

In addition to one or more of the above disclosed aspects or as an alternate wherein the surface treatment temperature is greater than or equal to 180° F. and the heating time duration is less than or equal to 10 minutes

In addition to one or more of the above disclosed aspects or as an alternate wherein the surface treatment solution comprises a water, an alkali solution, and acidic solution, a paint, a conversion coating solution, an electro-less nickel solution, a trivalent chromium process solution, a polymer, or a combination comprising at least one of the foregoing.

In addition to one or more of the above disclosed aspects or as an alternate further comprising washing the heat transfer tubes with a wash solution, wherein the wash solution comprises water, a solvent, a benign solution, or a combination comprising at least one of the foregoing.

In addition to one or more of the above disclosed aspects or as an alternate further comprising recycling the collected surface treatment solution from the second manifold to a point along the flowpath that is upstream of the second manifold.

In addition to one or more of the above disclosed aspects or as an alternate wherein recycling further comprises pumping the collected surface treatment solution from the second manifold to a point along the flowpath that is at, or upstream of, the inlet.

In addition to one or more of the above disclosed aspects or as an alternate further comprising monitoring a concentration of a species of the surface treatment, or proxy therefor, at a point along the flowpath.

In addition to one or more of the above disclosed aspects or as an alternate further comprising monitoring a concentration of a species of the surface treatment, or proxy therefor, at the outlet.

In addition to one or more of the above disclosed aspects or as an alternate wherein the stopping further comprises stopping the flow of the surface treatment solution based on a concentration of the surface treatment species, or proxy therefor, measured along the flowpath.

In addition to one or more of the above disclosed aspects or as an alternate wherein the forming further comprises wherein the conformal surface treatment has a thickness of less than or equal to 10 microns.

In addition to one or more of the above disclosed aspects or as an alternate wherein the surface treatment solution includes water, or alkalized water.

In addition to one or more of the above disclosed aspects or as an alternate wherein forming the conformal surface treatment along an internal surface of the heat exchanger further comprises forming the conformal surface treatment along the first manifold, the plurality of heat transfer tubes, the second manifold, and a plurality of interconnections therebetween,

In addition to one or more of the above disclosed aspects or as an alternate wherein forming the conformal surface treatment along an internal surface of the heat exchanger further comprises forming the conformal surface treatment along the inlet, the exterior surface of the plurality of heat transfer tubes, the outlet, the internal surface of the shell wall, and a plurality of interconnections therebetween.

A chiller comprising a plurality of heat exchange tubes, wherein a conformal surface treatment is disposed on an internal surface of the plurality of heat exchange tubes and wherein the conformal surface treatment is formed from the method of any one or more of the above disclosed aspects or as an alternate.

A chiller comprising a plurality of heat exchange tubes, wherein a conformal surface treatment is disposed on an internal surface of the plurality of heat exchange tubes and wherein the conformal surface treatment is formed from the method of any one or more of the above disclosed aspects or as an alternate and wherein the conformal surface treatment comprises a thickness of less than 1,000 nanometers.

### BRIEF DESCRIPTION OF THE DRAWINGS

The following descriptions should not be considered limiting in any way. With reference to the accompanying drawings, like elements are numbered alike:

FIG. 1 is an illustration of the disclosed method steps.

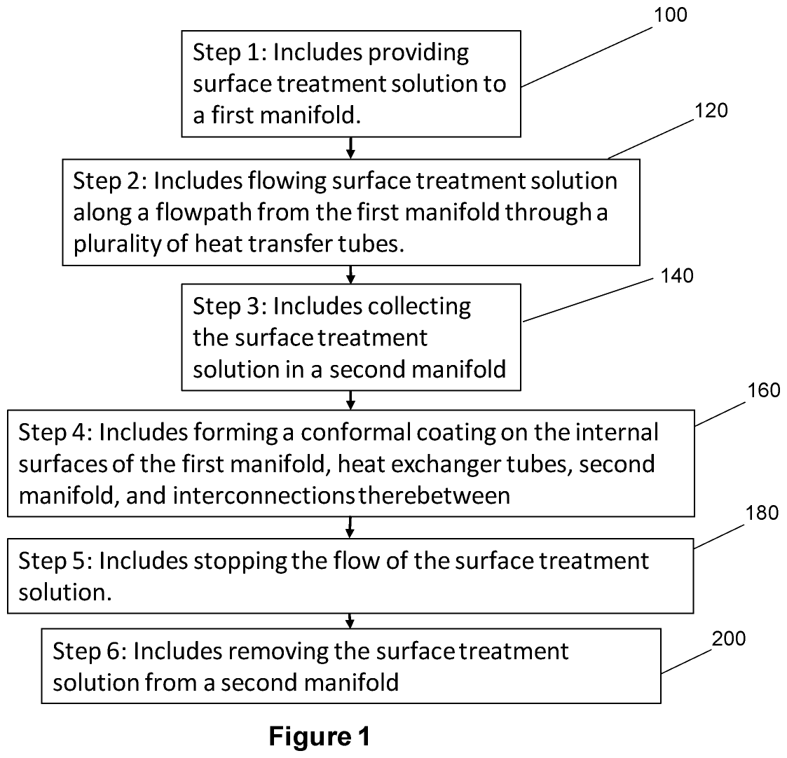

FIG. 2 is a schematic illustration of a chiller system prepared for the disclosed methods.

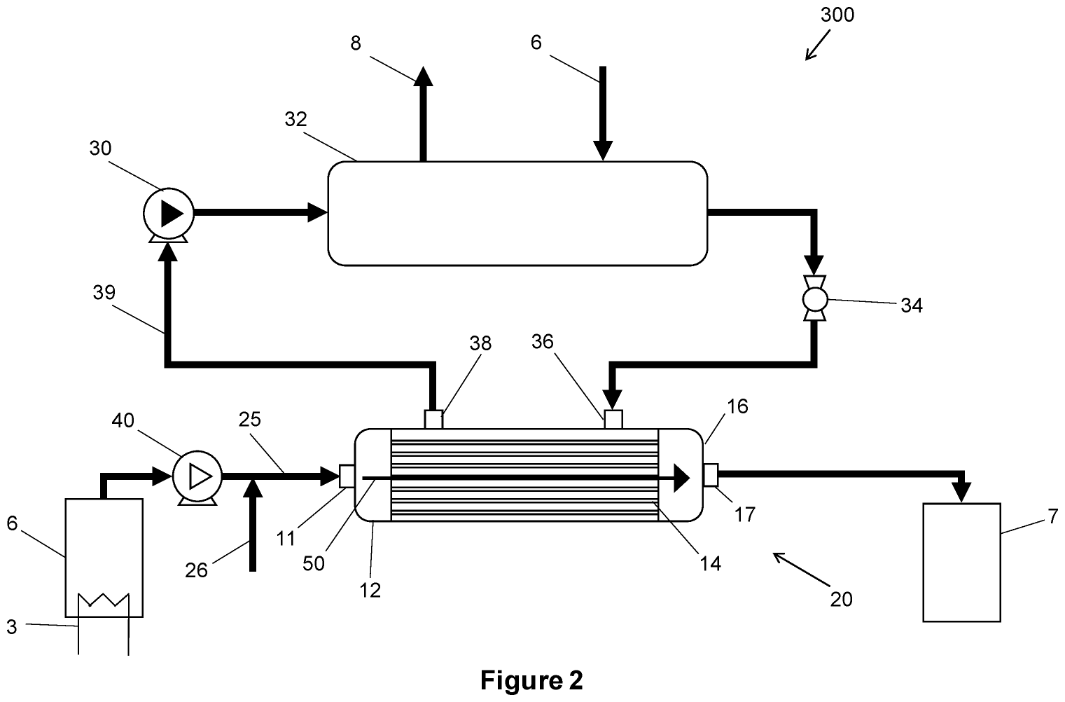

FIG. 3 is a schematic illustration of a chiller system prepared for the disclosed methods.

FIG. 4 is a schematic illustration of a heat exchanger prepared for the disclosed methods

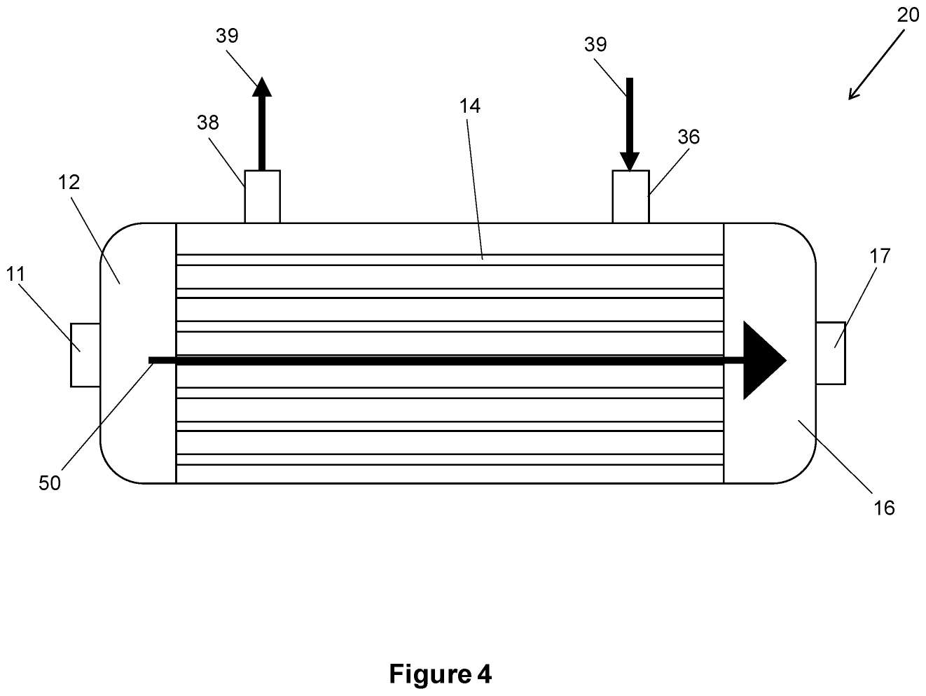

FIG. 5 is a schematic illustration of a heat exchanger having a turn manifold and prepared for the disclosed methods

### DETAILED DESCRIPTION

A detailed description of one or more embodiments of the disclosed apparatus and method are presented herein by way of exemplification and not limitation with reference to the Figures.

A significant challenge to deploying aluminum parts in HVAC systems can be the susceptibility of aluminum to corrosion and fouling. In order to reduce the rate of corrosion, a surface treatment can be applied to protect the base aluminum or aluminum alloy material from corrosive interactions (e.g., with water and/or impurities therein, such as chlorine, fluorine, and other dissociated ionic species). However, surface treatments (e.g., coatings) can be compromised by mechanical damage when the treatment processes are carried out prior to other manufacturing operations (e.g., fabrication and assembly steps). When a surface treatment is applied to dis-assembled parts prior to assembly, the assembly processes can increase the risk that the desired surface protection is compromised, at least along interconnecting points of the assembly (e.g., braze locations, mechanical securements, and the like). Resulting discontinuities in surface protection can lead to premature failure of the base material due to corrosive activity. For example, in the manufacturing of heat exchanger tubes, masking, coating the tubes prior to tube expanding, and/or brazing the tubes into a heat exchanger assembly can leave portions (e.g., interconnections, such as braze joints and seams), unprotected as they would have not received the same surface treatment that the surrounding materials received.

Another challenge with the surface treatment of heat exchanger tubes can be the presence of surface features on the surface of the tubes. Surface features can include fins, spikes, or other protrusions recessing into or extending from the internal and/or external surface or the tube. These features can be configured to break up boundary layer flow and increase the local convective heat transfer coefficient. When coatings are applied after the formation of surface features the coatings can partially defeat the benefit of the surface feature by filling the recesses, and/or covering the protrusions of the feature thereby limiting its effectiveness.

In solving these problems the applicants have developed a method of in-situ application of a coherent conformal surface treatment to an internal surface of heat transfer tubes of a heat exchanger of a chiller. As used herein in-situ can refer to when a chiller 300 is at least partially assembled and partially operational (e.g., including in preparation for, during, or following, factory sub-assembly testing, assembly testing, or full system testing, or in preparation for, during, or following, customer acceptance testing, or qualification testing, or the like). In-situ can include when fluid circuits of the chiller 300 have been fluidly isolated from other components of the chiller 300, such as compressor 30, evaporator 32, and expansion device 34 to allow for once-through flow rather than recirculating flow through a loop. In-situ can include when the chiller 300 is completely assembled and fully operational. In-situ can include when the chiller 300 is sufficiently assembled and installed such that it is capable of provide cooling to a thermal load. For example, in-situ can include when the chiller 300 is completely assembled and installed such that it is capable of provide cooling to a customer thermal load.

With reference to the accompanying figures, the method involves a first step 100 which can include providing a surface treatment solution to a first manifold 12 of a heat exchanger 20 of a chiller 300. The chiller 300 can include a refrigerant flow circuit 39 including a compressor 30, heat absorbing heat exchanger 32 (e.g., interfacing with a customer load, e.g., heat source stream inlet 6 and heat source stream outlet 8), expansion device 34, and a heat rejecting heat exchanger (e.g., heat exchanger 20). As used herein providing can include pouring, flowing, loading, filling, charging, or otherwise delivering the surface treatment solution to the first manifold 12. The providing can be done in a continuous process. For example, a surface treatment solution can be flowed from a reservoir 6 along a supply path 25 through a tube side inlet port 11 into the first manifold 12 in a batch, semi-continuous, or continuous process.

Once the surface treatment solution is provided to the inlet, (e.g., to the first manifold 12 through tube side inlet port 11, or shell side inlet port 36), a second step 120 can include urging a flow of the surface treatment solution along a flowpath 50 from the inlet, past a plurality of heat transfer tubes 14, of the heat exchanger 20. The inlet can be an inlet manifold of the heat exchanger 20. A flow inducing device 40 (e.g., a pump, ejector, or other flow inducing means) can be used to urge a flow of the surface treatment solution along the flowpath 50. The flow inducing device 40 can be disposed upstream of the inlet, e.g., when the flow is induced by pressurizing the inlet. The flow inducing device 40 can be disposed along the flowpath 50, e.g., between the inlet and the outlet, e.g., when the inlet is physically attached to a first heat exchanger and the outlet is physically attached to a physically separate second heat exchanger, allowing for plumbing therebetween. The flow inducing device 40 can be disposed downstream of the outlet, e.g., when the flow is induced by depressurizing the second manifold 16. The flow inducing device 40 can be a pumping device used in water circuit of a water cooled chiller 300.

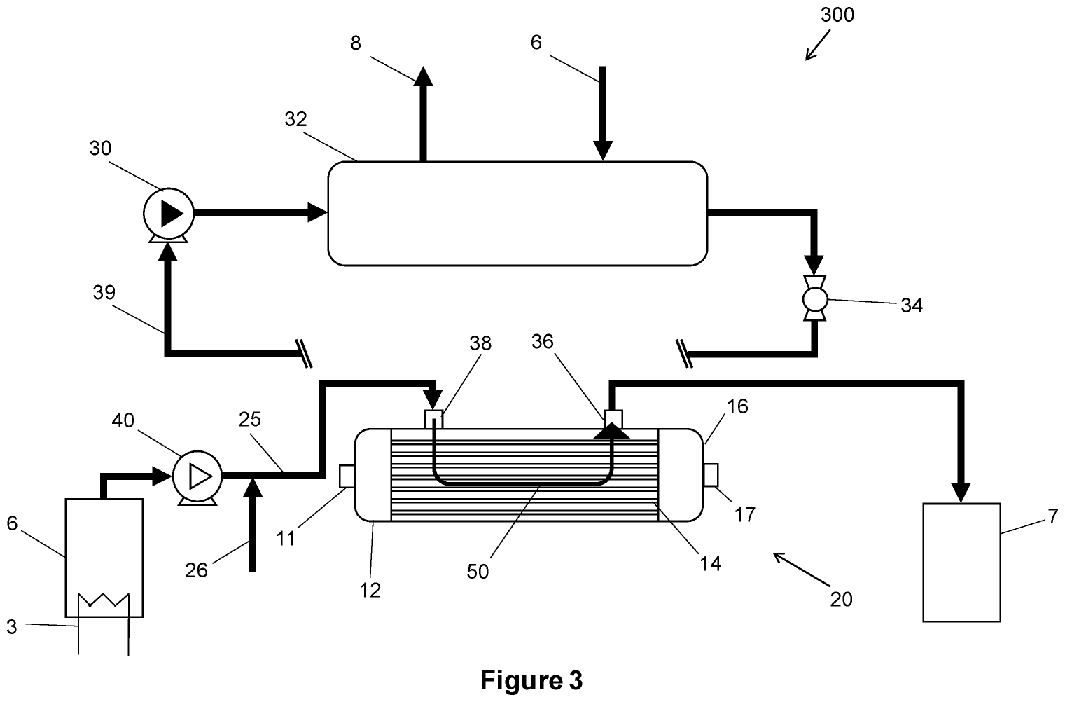

The surface treatment can also be applied to the exterior surfaces of the heat transfer tubes 14. The surface treatment solution can be introduced to the exterior surfaces of the heat transfer tubes 14 through shell side inlet port 36 and removed from the shell through shell side outlet port 38. The refrigerant flow circuit 39 can be disconnected (as indicated by parallel lines in the attached figures) to allow for a surface treatment solution to flow through the shell side of the heat exchanger 20 along flowpath 50 as shown in FIG. 3.

A third step 140 can include collecting the surface treatment solution, e.g., in the second manifold 16 of the heat exchanger 20, or in a collection tank 7. The outlet can include an exit manifold of a heat exchanger (e.g., exit manifold 16 of heat exchanger 20). Once the surface treatment solution flows past the plurality of heat transfer tubes 14 (e.g., through and/or around while in contact with, along the internal and/or external surfaces of, and the like) it can be collected. For example, the surface treatment solution can be collected in the second manifold 16, or in a reservoir disposed at an end of the flowpath 50. It should be understood that the outlet can be physically attached to the heat exchanger 20 or can be physically attached to a second, physically separate, heat exchanger (e.g., downstream of the heat exchanger 20), to allow for the treatment of surfaces of more than one heat exchanger arranged in serial flow relationship between the inlet and the outlet. At the outlet (e.g. at the second manifold 16), the concentration of one or more specific surface treatment species of the solution, or of species resulting from reactions therewith (e.g., reaction products), can be monitored. If the surface treatment solution collected in the outlet retains sufficient activity (e.g., sufficiently high concentration of surface treatment species or proxy therefor) then the collected surface treatment solution can be returned to a point upstream (e.g., an intermediate mixing point along the flowpath 50, back to the first manifold 12, back to an optional secondary supply flow path 26 or the like) in an optional recycle stream.

Solution concentration monitoring (e.g., at one or more points along the flowpath 50, such as downstream of the inlet or downstream of the first manifold 12) can allow for calculation of the average thickness of the surface treatment on the internal surfaces of the heat exchanger 20. One or more additional parameters can help improve the accuracy of the calculation of the average thickness of the surface treatment. Such parameters can include the flow rate of the solution through the heat exchanger 20, the time duration that the solution is flowed through the heat exchanger 20, the total mass, or mass flow rate, of the solution that is provided to the inlet, the total mass, or mass flow rate, of the solution that is removed from the outlet, the temperature of the solution at one or more points along the flowpath 50, the temperature of the surfaces at one or more points along the flowpath 50, or proxies thereof, and the like, or a combination including at least one or the foregoing. The calculated average thickness of the surface treatment can be used as a control parameter for the control of the surface treatment process, such as an indicator of when to provide surface treatment solution to the inlet, to start/stop the flow of surface treatment solution through the one or more heat exchangers to be treated, to start/stop recycle flow from the outlet, to remove surface treatment solution from the one or more heat exchangers to be treated, and the like.

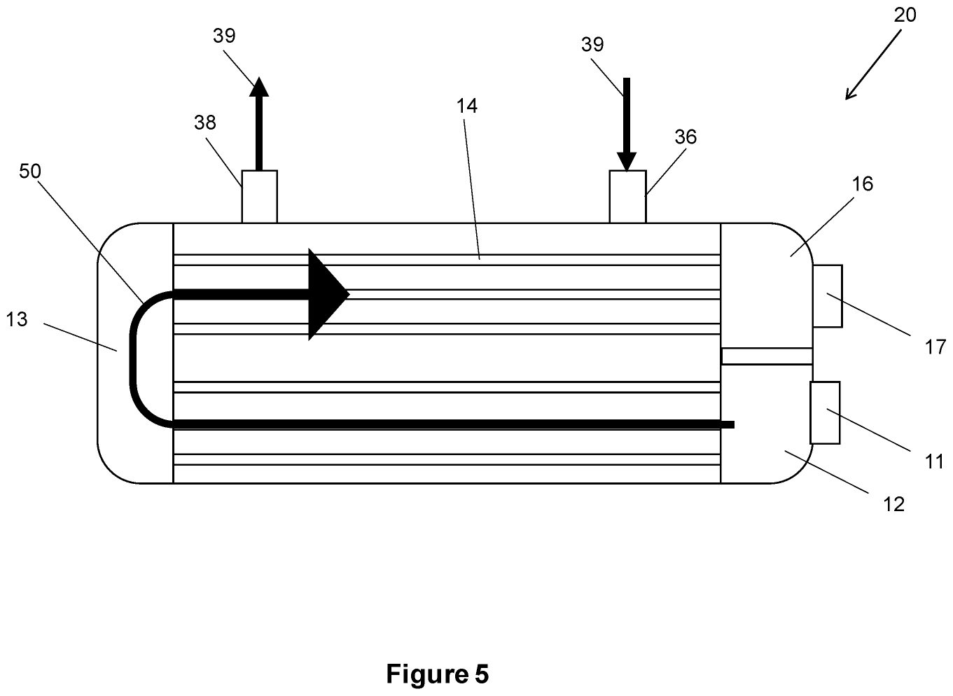

A fourth step 160 can include forming a conformal surface treatment along an internal surface of the inlet (e.g., first manifold 12), the internal and/or external surfaces of heat transfer tubes 14, the outlet (e.g., second manifold 16), the internal surfaces of the shell, and a plurality of interconnections therebetween, or a combination including at least one of the foregoing. As shown in FIG. 5, the flowpath 50 can include one or more turn manifolds 13 for interconnecting two or more pluralities of heat transfer tubes 14 within a single heat exchanger 20. When included, conformal surface treatments can be formed along the internally exposed surfaces of the one or more turn manifolds simultaneously with the formation of conformal surface treatments on the heat transfer tubes 14 using the disclosed methods.

The average thickness of the conformal surface treatment can vary along the flowpath 50. The average thickness of the surface treatment can be greatest at the inlet (e.g., at the first manifold 12). For example, where the concentration of the surface treatment species is the highest, where the surface treatment solution can have the longest contact time with the internal surface of the heat exchanger 20, and/or where the largest voltage difference or induced current is formed (e.g., such as during an electrolytic surface treating operation). In HVAC systems (e.g., chiller 300), the condenser cold side inlet can be a location that see the highest temperature difference between the hot side and cold side of the heat exchanger. These high temperature differences can lead to higher corrosion rates at the inlet in comparison to other locations along the flowpath 50. The present methods can allow for buildup of greater surface treatment thickness at the heat exchanger cold inlet. Accordingly, the disclosed methods provide for efficient treatment of the surfaces susceptible to corrosion and allows for targeted treatment thicknesses to the locations on those surfaces that are most likely to see the worst corrosive conditions during operation.

The thickness of the surface treatment can depend on the mass flux of surface treatment species to the internal surface. At the surface, the surface treatment species can adhere, chemically bind, conglomerate, deposit, react, or otherwise form the conformal surface treatment. Flux to the internal surface can be a function of the concentration of surface treatment species, the velocity of those species or a proxy therefor (e.g., such as bulk fluid velocity, temperature, and/or mass diffusion rate), and the time duration that the surface treatment solution is in contact with the surface to be treated.

While numerically, the fourth step can imply that the step occurs after the first, second, and third steps, this is not necessarily the case, at least not for the entirety of the fourth step. The formation of the conformal surface treatment starts when all the conditions for the surface treatment to form are met. These conditions depend on the type of surface treatment that is applied, and the type of aluminum or aluminum alloy to which the surface treatment is applied. Formation of the conformal surface treatment ends when all the conditions for the surface treatment to form are not met.

Conditions for the surface treatment to form can include presence and concentration of the surface treatment solution, contact duration, and surface temperature, parameters which can also be a function of the type of surface treatment desired. Some examples of surface treatments contemplated by the applicants include paints, autocatalytic coatings (e.g., conversion coating, electroless nickel, sol-gel), plastic coatings (e.g., polytetrafluoroethylene (PTFE)), forming of passive an oxide layer (e.g., formation of boehmite), electrolytic coating (e.g., plating and anodizing) and the like. An example of a surface treatment solution can include a solution composition comprising a trivalent chromium salt and an alkali metal hexafluorozirconate. For electrolytic processes, electrodes can be arranged at one or more locations along the flowpath 50 to facilitate formation of the conformal surface treatment. For example, one or more cathode electrodes can be disposed in electrical communication with the inlet (e.g., first manifold 12), the heat transfer tubes 14, and the outlet (e.g., second manifold 16) and can be configured to establish voltage gradient relative to an anode electrode to facilitate the electrolytic coating process.

In an example, a boehmite surface treatment can be formed by exposing the aluminum or aluminum alloy to hot water for a duration of time, such as about 150° F. for greater than or equal to about 20 minutes, or about 160° F. for greater than or equal to about 10 minutes, or about 170° F. for greater than or equal to about 5 minutes, or about 180° F. for greater than or equal to about 2 minutes. Furthermore, hot water vapor or steam can be introduced to produce boehmite more rapidly or to increase boehmite layer thickness. Such a process can result in formation of a conformal surface treatment of boehmite of less than or equal to about 1,000 nanometers (nm), or less than or equal to about 800 nm, or less than or equal to about 600 nm, or less than or equal to about 500 nm, or less than or equal to about 400 nm, or less than or equal to about 300 nm, or between about 10 nm and about 300 nm, or between about 10 nm and about 200 nm, along exposed surfaces. Fluid solutions (e.g., water, alkalized water) used in a boehmite forming process can be heated before being flowed through flowpath 50. For example, a heater 3 can be disposed in thermal communication with the reservoir 6, the supply path 25, or both. Alternatively, or in addition, the water can be heated within heat exchanger 20. For example, by utilizing a heating fluid flowed through the shell side of heat exchanger 20, e.g., into the shell side inlet port 36 and out the shell side outlet port 38. The heating fluid can be a fluid disposed in the refrigerant flow circuit 31, and can be used to heat the heat transfer tubes 14 to a target temperature for the formation of the surface treatment. The boehmite forming process can be carried out with alkaline aqueous solutions. In this way, the reactivity of the solution can be increased, thereby reducing the duration of time needed to form the surface treatment in comparison to treatments without alkalizing agents.

A fifth step 180 can include stopping the flow of the surface treatment solution through the heat transfer tubes 14 of the heat exchanger 20. Once the conditions for forming the conformal surface treatment have been met the flow of surface treatment solution can be stopped and the remaining solution can be removed from the chiller 300. As used herein, stopping the flow of surface treatment can include reducing or eliminating any non-negligible pressure differences between the inlet (e.g., first manifold 12) and the outlet (e.g., second manifold 16), such as stopping flow inducing device 40 from urging flow along the flowpath 50, stopping a device from pressurizing the inlet (e.g., first manifold 12), stopping a device from reducing the pressure of the outlet (e.g., second manifold 16), or the like. It can also refer to a process of reducing the concentration of surface treatment solution along the flowpath 50. For example, it can refer to flowing a washing, drying, pushing fluid, or the like through and/or past the inlet (e.g., first manifold 12), the heat transfer tubes 14, and the second manifold 16, to wash the surface treatment solution from the heat exchanger 20. For example, an optional second supply flow path 26 can be merged into the supply path 25 to allow for a transition from flowing surface treatment solution to the inlet port 11 to flowing a second fluid (e.g., water, an aqueous solution, a washing solution, a drying fluid, passivation fluid, air, or the like) to the inlet port 11, thereby reducing the concentration of the surface treatment solution in the first manifold 12 accordingly.

An indicator of completion of a successful washing process can include when the concentration of surface treatment solution at the second manifold 16 is equal (or within measurement inaccuracy) to the concentration of the surface treatment solution in the washing fluid supply, e.g., the second supply flow path 26. For example, based on a concentration of a surface treatment species at the second manifold 16 the flow of a surface treatment solution can be stopped and the flow of a washing fluid can be started along the second supply flow path 26. It should be understood that the second fluid can be provided to the first manifold 12 in any suitable way, such as by pumping from an optional separate fluid reservoir. In this way the concentration of the surface treatment species can be gradually reduced along the flowpath 50 until the concentration at the second manifold 16 reaches an acceptable level to indicate washing (or drying) is complete.

A sixth step 200 can include removing the surface treatment solution from the chiller and can be performed using any suitable method of removal. In an example the surface treatment solution can be removed by pushing the solution from the first manifold 12 through the heat transfer tubes 14, and out of the outlet port 17 of the second manifold 16 with a pusher fluid (e.g., water, air, or the like). The surface treatment solution removed from the heat exchanger 20 can be collected in an optional collection tank 7.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of in-situ application of a conformal surface treatment to an internal surface of a heat exchanger of a chiller comprising:
providing a surface treatment solution to an inlet of the heat exchanger of the chiller,
urging a flow of the surface treatment solution along a flowpath from the inlet past a plurality of heat transfer tubes to an outlet of the heat exchanger of the chiller,
collecting the surface treatment solution,
forming the conformal surface treatment along an internal surface of the first manifold, the plurality of heat transfer tubes, the second manifold, and a plurality of interconnections therebetween,
stopping the flow of the surface treatment solution, and
removing the surface treatment solution from the chiller.

2. The method of claim 1, wherein forming the conformal surface treatment further comprises forming the conformal surface treatment having a varying thickness along the flowpath and wherein the thickness is greatest at the inlet.

3. The method of claim 1, wherein the forming further comprises heating the plurality of heat transfer tubes to a surface treatment temperature for a heating time duration.

4. The method of claim 1, wherein the surface treatment temperature is greater than or equal to 140° F. and the heating time duration is less than or equal to 30 minutes.

5. The method of claim 1, wherein the surface treatment temperature is greater than or equal to 180° F. and the heating time duration is less than or equal to 10 minutes.

6. The method of claim 1, wherein the surface treatment solution comprises a water, an alkali solution, and acidic solution, a paint, a conversion coating solution, an electro-less nickel solution, a trivalent chromium process solution, a polymer, or a combination comprising at least one of the foregoing.

7. The method of claim 1, further comprising washing the heat transfer tubes with a wash solution, wherein the wash solution comprises water, a solvent, a benign solution, or a combination comprising at least one of the foregoing.

8. The method of claim 1, further comprising recycling the collected surface treatment solution from the second manifold to a point along the flowpath that is upstream of the second manifold.

9. The method of claim 8, wherein recycling further comprises pumping the collected surface treatment solution from the second manifold to a point along the flowpath that is at, or upstream of, the inlet.

10. The method of claim 1, further comprising monitoring a concentration of a species of the surface treatment, or proxy therefor, at a point along the flowpath.

11. The method of claim 1, further comprising monitoring a concentration of a species of the surface treatment, or proxy therefor, at the outlet.

12. The method of claim 1, wherein the stopping further comprises stopping the flow of the surface treatment solution based on a concentration of the surface treatment species, or proxy therefor, measured along the flowpath.

13. The method of claim 1, wherein the forming further comprises wherein the conformal surface treatment has a thickness of less than or equal to 10 microns.

14. The method of claim 1, wherein the surface treatment solution includes water, or alkalized water.

15. The method of claim 1, wherein forming the conformal surface treatment along an internal surface of the heat exchanger further comprises forming the conformal surface treatment along the first manifold, the plurality of heat transfer tubes, the second manifold, and a plurality of interconnections therebetween.

16. The method of claim 1, wherein forming the conformal surface treatment along an internal surface of the heat exchanger further comprises forming the conformal surface treatment along the inlet, the exterior surface of the plurality of heat transfer tubes, the outlet, the internal surface of the shell wall, and a plurality of interconnections therebetween.

17. A chiller comprising a plurality of heat exchange tubes, wherein a conformal surface treatment is disposed on an internal surface of the plurality of heat exchange tubes and wherein the conformal surface treatment is formed from the method of claim 1.

18. A chiller comprising a plurality of heat exchange tubes, wherein a conformal surface treatment is disposed on an internal surface of the plurality of heat exchange tubes and wherein the conformal surface treatment is formed from the method of claim 1 and wherein the conformal surface treatment comprises a thickness of less than 1,000 nanometers.
